(19) United States
(12) Patent Application Publication
(10) Pub. No.: US 2014/0252822 A1
(43) Pub. Date: Sep. 11, 2014

(54) Fastening Textile For Safety Belt

(71) Applicant: Expliseat SAS, Paris (FR)

(72) Inventor: Vincent Tejedor, Sartrouville (FR)

(21) Appl. No.: 14/350,360

(22) PCT Filed: Oct. 5, 2012
(86) PCT No.: PCT/EP2012/069763

§ 371 Date: Apr. 7, 2014

(30) Foreign Application Priority Data
Oct. 7, 2011 (FR) 11 03054

(51) Int. Cl. B60R 22/26; B60R 22/28; B60R 22/18; B60R 22/12

(52) U.S. Cl. CPC B60R 22/26; B60R 22/12; B60R 22/28; B60R 22/18; B60R 2022/266; B60R 2022/286
USPC 297/232; 29/897.2; 297/468; 297/471; 297/472

(57) ABSTRACT

A main object of the invention is a textile strip forming at least partially a safety belt intended to be fastened to a fixed structure of a seat or of a passenger compartment, characterised in that a notch is formed on the textile strip (10) in order to allow for the folding of the textile strip onto itself in such a way as to surround the fixed structure of the seat or of the passenger compartment by insertion of an end of the textile strip into the notch made in the textile strip.

### TECHNICAL FIELD

This invention relates to the field of collective passenger transport, in particular by road, rail or air. It relates more particularly to the production of a system or principle for fastening a safety belt to a rigid structure, for individual seats or for benches or set of seats. It relates to a textile strip, as well as a seat, a set of seats and a vehicle comprising such a textile strip, and also an associated method and device for fastening.

### PRIOR ART

Seats allowing for the transport of passengers must satisfy demanding standards in the case of an accident. The passenger must not be projected in the passenger compartment, and is for this purpose retained by a safety belt. The constraints vary according to the method of movement used, with the most drastic applying to air transport.

In the framework of individual transport by automobile, much work has improved the original invention of “protective straps” of Gustave Désiré Lebeau (patent filed in 1903): adaptation of the position of the belt according to the morphology of the passenger (WO 92/22442), the adding of a belt pre-tensioner in order to limit the risk of shearing (WO 98/34817), improvement of the buckle fasteners (WO 2006/080252).

In the framework of collective passenger transport, the safety belt often remains a device with two attachment points, without pre-tensioner. The belt is attached to the two ends of the seatback/seat angle of the seat, and the passenger adjusts the size of the belt by sliding the free piece into the buckle of the safety belt. The two ends of the belt, on fastening points, are attached to a rigid structure, generally made of steel or aluminium. This structure is itself fastened to the seat by a system of screws, rivets or snap hooks.

Different principles for fastening safety belts are known in prior art. Patent application FR 2 750 095 A1 describes a fastening system for the anchoring of a safety belt fastened by sewing around a bar of the structure of the vehicle. Patent application FR 2 400 917 A1 describes a device for maintaining a safety belt by sewing around a horizontal bar. U.S. Pat. No. 7,591,510 describes a safety belt adapted for children and fixed to a fixed bar by sewing. Patent application JP 62-214036 A describes a vehicle for two passengers and the use of a safety belt provided with removable means of fastening.

The main function of the safety belt is to retain the passenger during an impact. The belt must as such stop the passenger and transfer his kinetic energy to the structure. A slight elasticity of the belt makes it possible to absorb the impact sustained by the structure and by the passenger. The fastening allows for the transfer of energy between the belt and the structure, it must be dimensioned in such a way as to resist the force exerted by the passenger in case of impact.

The usual technique of fastening the safety belt consists in sewing an end of the belt around a metal part, generally made of steel. This metal part can then be fastened to the structure of the seat, either rigidly by means of screws, or by means of a snap hook. The screws used must be extremely solid: the standard in the field of aviation recommends AN6 screws made of steel, with hex head and a diameter of ⅜ of an inch, which is about 9.5 mm. The snap hooks can be lighter, but they require to be attached a shaft axis which is added in general to the structure of the seat.

The resistance of the conventional fastening system as such requires relatively heavy metal parts. The modern design of means of transport attempts to limit as much as possible the weight of the structure: the higher the unladen weight is, the more energy the means of transport will need to move, and the more greenhouse gases it will emit. By limiting the weight, the system or principle of fastening according to the invention contributes to protecting the environment.

In addition to the substantial weight of the normal techniques for fastening, is added a complexity linked to the large number of parts: the metal clasp sewn on the belt, the screws or the snap hook, as well as the attaching zone on the structure of the seat. In the case of commercial passenger transport, in particular in the aeronautical industry, the quality and the follow-up of each of these parts induces a high degree of complexity during the manufacture of the seat, and sometimes after it is sold in the case of parts follow-up.

In terms of the safety of persons, the presence of metal parts in the passenger compartment is always a handicap: in case of unusual impact, for example of a standing passenger against the system for fastening the belt, the metal parts constitute sharp objects. They can cause lesions that are more substantial than the bare structure due to their rigidity and the presence of sharp edges, whether on the screws or on the snap hook.

Finally, again in environmental terms, the recycling of a large number of small parts is always difficult, especially when they are not all constituted of the same material. By limiting the number of parts comprising the system for fastening the safety belt, recycling it is facilitated

### DESCRIPTION OF THE INVENTION

The invention has for purpose to overcome at least partially the needs mentioned hereinabove and the disadvantages relating to the embodiments of prior art.

In particular, this invention was designed with the aforementioned problems in mind: simplifying the system or principle of fastening the safety belt to the seat, decreasing its weight and its volume, improving the safety of the passenger and respecting the environment. The invention is particularly advantageous for collective passenger transport, in particular by road, rail or air.

This invention therefore proposes a system or principle of fastening the safety belt of very low weight and of low complexity, while still maintaining a very high level of safety. This system uses the excellent mechanical properties of innovative textiles, and incorporates the problem of the fastening of the safety belt right from the designing of the seat. It is therefore no longer necessary to have a metal fastening of the belt to the structure of the seat.

As such, the invention has for object, according to one of its aspects, a textile strip forming at least partially a safety belt intended to be fastened to a fixed structure of a seat or of a passenger compartment, characterised in that a notch is formed on the textile strip in order to allow for the folding of the textile strip on itself in such a way as to surround the fixed structure of the seat or of the passenger compartment by the insertion of an end of the textile strip into the notch made in the textile strip.

The invention also has for object, according to another of its aspects, a textile strip forming at least partially a safety belt intended to be fastened to a fixed structure of a seat or of a passenger compartment, characterised in that it comprises, over at least one zone of the textile strip intended to surround the fixed structure of the seat or of the passenger compartment, a thermosetting resin, pre-impregnated on the textile strip, or a thermoplastic resin.

The use of the terms “thermosetting” and “thermoplastic” must not limit the invention to resins that harden under the effect of heat only. In particular, the thermosetting or thermoplastic resin can be hardened for example under the effect of the heat, by the adding of a catalyst (in particular by redox reaction), by electromagnetic radiation (visible, infrared, ultraviolet, X or γ).

The notch can be made by cutting the textile strip in the direction of the weft and of the warp.

In order to prevent the ends of free threads from fraying by friction and abrasion and the notch from propagating, a reinforcement of at least one portion of the contour of the notch can be carried out.

At least one portion of the contour of the notch can be reinforced by a folding of a cut portion of the textile strip on the textile strip and sewing of the cut portion on the textile strip.

At least one portion of the contour of the notch can be reinforced by extra sewing.

At least one portion of the contour of the notch can be reinforced by the adding of a material surrounding said at least one portion of the contour of the notch, with this material being sewn on the textile strip on either side of said at least one portion of the contour of the notch.

At least one portion of the contour of the notch can be reinforced by the adding of a metal and/or of a curable material on said at least one portion of the contour of the notch. The metal can for example be stainless steel, aluminium or titanium: a strip of metal can be folded and pinched at the edge of the notch. The curable material can for example be a thermosetting resin or a thermoplastic resin, for example chosen from among those mentioned hereinafter. The metal and/or the curable material can allow for an agglomeration of the free ends of the threads of the textile strip and prevent fraying.

The textile strip can comprise two textile sub-strips sewn together longitudinally edge-to-edge, partially in such a way as to form the notch between the unsewn edges of the two sub-strips.

The textile strip can comprise two textile sub-strips sewn together longitudinally face-to-face, partially in such a way as to form the notch between the unsewn faces of the two sub-strips.

The partial sewing of two sub-strips in order to allow for the formation of the notch can make it possible to have a contour of the notch constituted of continuous threads and not of cut threads.

The textile strip can comprise a thermosetting resin. The thermosetting resin can be chosen from among epoxy resins, polyesters and/or vinylesters.

The textile strip can comprise a thermoplastic resin. The thermoplastic resin can be chosen from among polyether ether ketones (PEEK), polyetherimides (PEI) and/or polyphenylenesulfides (PPS).

The thermoplastic resin can for example be incorporated into the textile strip in the form of powder or fibres.

The use of a thermoplastic resin or thermosetting can make it possible to make a textile strip buckle by rigidifying the textile strip locally on said at least one zone of the textile strip intended to surround the fixed structure of the seat or of the passenger compartment.

A solid support, allowing for the fastening of a snap hook, can be fixed to an end of the textile strip.

Each end of the textile strip can be provided with an attaching support of the safety belt. As such, the textile strip can comprise at each of its ends an attaching support in order to allow for the attaching of the textile strip to at least one portion of another safety belt, for example another textile strip according to the invention. As such, the textile strip can be used between two adjacent seats and comprise two attachment supports for each of the seats, for example two male or female attachment supports, or one male and one female.

The invention further has for object, according to another of its aspects, a seat characterised in that it comprises a textile strip such as defined previously.

The seat can comprise a textile strip comprising, over at least one zone of the textile strip intended to surround the fixed structure of the seat or of the passenger compartment, a thermosetting resin, pre-impregnated on the textile strip, or a thermoplastic resin, said at least one zone of the textile strip surrounding the fixed structure by forming a buckle extending around the fixed structure on an angle strictly greater than 180°, more preferably greater than 240°.

An absorber can be inserted between the textile strip and the fixed structure. The absorber can be constituted of a gel, dissipating an impact by deformation and by heating. The absorber can further be constituted of a foam delaying an impact by deformation, possibly elastic.

The textile strip can surround the fixed structure without intermediate fastening.

The invention further has for object, according to another of its aspects, a set of at least two adjacent seats comprising first and second adjacent seats, characterised in that at least one of the first and second seats is a seat such as defined previously, and in that the textile strip forms at least partially the safety belt of the first seat and the safety belt of the second seat.

The invention further has for object, according to another of its aspects, a set of at least two adjacent seats comprising first and second adjacent seats, characterised in that the same textile strip forms at least partially the safety belt of the first seat and the safety belt of the second seat.

The invention further has for object, according to another of its aspects, a vehicle comprising a seat such as defined previously or a set such as defined previously.

“Vehicle” means any means of transport or of moving at least one passenger, for example a plane, a car, a train, a baby carriage, a cable car, a chairlift, a boat, a gondola of a thrill attraction, among others.

The textile strip can be fastened to a fixed structure of at least one seat. The textile strip can further be fastened to a fixed structure of the passenger compartment of the vehicle.

The invention further has for object, according to another of its aspects, a method for fastening the safety belt to a fixed structure of a seat or of a passenger compartment, characterised in that it comprises the following step:

a textile strip is folded back such as defined previously, comprising a notch, onto itself in order to form a buckle of textile strip surrounding the fixed structure of the seat or of the passenger compartment by inserting an end of the textile strip into the notch made in the textile strip.

The invention further has for object, according to another of its aspects, a method for fastening the safety belt to a fixed structure of a seat or of a passenger compartment, characterised in that it comprises the following step:

the fixed structure of the seat or of the passenger compartment is surrounded with a textile strip such as defined previously, comprising a pre-impregnated thermosetting resin or a thermoplastic resin.

Such a method can comprise the following steps:

the textile strip comprising on said at least one zone a pre-impregnated thermosetting resin is prepared,

the textile strip is placed around the fixed structure of the seat or of the passenger compartment,

the pre-impregnated thermosetting resin of said at least one zone of the textile strip is hardened by polymerisation, in particular by the adding of a catalyst and/or an increase in temperature.

The method can alternatively comprise the following steps:

the textile strip is placed around the fixed structure of the seat or of the passenger compartment,

a thermoplastic resin is deposited on said at least one zone of the textile strip surrounding the fixed structure,

the thermoplastic resin is hardened, in particular by an increase in temperature.

The invention further has for object, according to another of its aspects, a device for fastening a safety belt, with a safety belt being folded onto itself in order to form a textile strip buckle surrounding a fixed structure of the seat or of the passenger compartment, without intermediate fastening, characterised in that the buckle of textile strip is made by inserting an end of the textile strip into a hole made in the other end.

In this application, the terms “hole” and “notch” designate the same thing.

The invention further has for object, according to another of its aspects, a device for fastening a safety belt, with a safety belt being folded onto itself in order to form a textile strip buckle surrounding a fixed structure of the seat or of the passenger compartment, without intermediate fastening, characterised in that the buckle of textile strip is made by gluing the buckle of textile strip around the fixed structure of the seat or of the passenger compartment, using a polymerisable resin or a thermoplastic resin.

In this application, the terms “glue” and “gluing” are to be considered in relation with the use of a resin on the textile strip that hardens in order to allow for the maintaining of the textile strip around the fixed structure. This maintaining does not necessarily involve a mechanical connection between the textile strip and the fixed structure: the gluing can simply agglomerate between them the fibres of the textile strip.

The polymerisable resin can in particular be a thermosetting resin.

The device can be applied to two adjacent seats, two adjacent safety belts being coupled, and sharing the same buckle of textile strip.

The invention further has for object, according to another of its aspects, a device for fastening a safety belt, with a safety belt being folded onto itself in order to form a textile strip buckle surrounding a fixed structure of the seat or of the passenger compartment, without intermediate fastening, characterised in that it is applied to two adjacent seats, two safety belts being coupled and sharing the same buckle of textile strip.

The textile strip, the seat, the set of at least two adjacent seats, the vehicle, the method and the device according to the invention can comprise any of the aforementioned characteristics, taken separately or according to all technically permissible combinations with other characteristics

### BRIEF DESCRIPTION OF THE DRAWINGS

The invention can be better understood when reading the following detailed description, of examples of implementation that do not limit the latter, as well as when examining the figures, diagrammatical and partial, of the annexed drawing, wherein:

FIG. 1 is a perspective view of a set (or bench) of three adjacent seats in accordance with the invention, associated with the orthogonal system used,

FIG. 2 is a front view of a textile strip with notch according to the invention placed around a fixed structure, with two useable ends of the strip,

FIG. 3 is a front view of a textile strip with notch according to the invention placed around a fixed structure, with one usable end of the strip,

FIGS. 4 to 7 show alternative embodiments and/or reinforcement of a notch for a textile strip according to the invention,

FIG. 8 is a front view of a textile strip with thermosetting or thermoplastic resin according to the invention placed around a fixed structure,

FIG. 9 is a front view of a textile strip comprising one useable end with sewing of a solid support allowing for the fastening of a safety belt by snap hook, and

FIG. 10 is a profile view of a textile strip according to the invention showing the insertion of an absorber between the buckle of textile strip and the fixed structure.

In all of these figures, identical references can designate identical or similar elements.

In addition, the different portions shown in the figures are not necessarily shown according to a uniform scale, in order to make the figures more legible.

### DETAILED DESCRIPTION OF PARTICULAR EMBODIMENTS

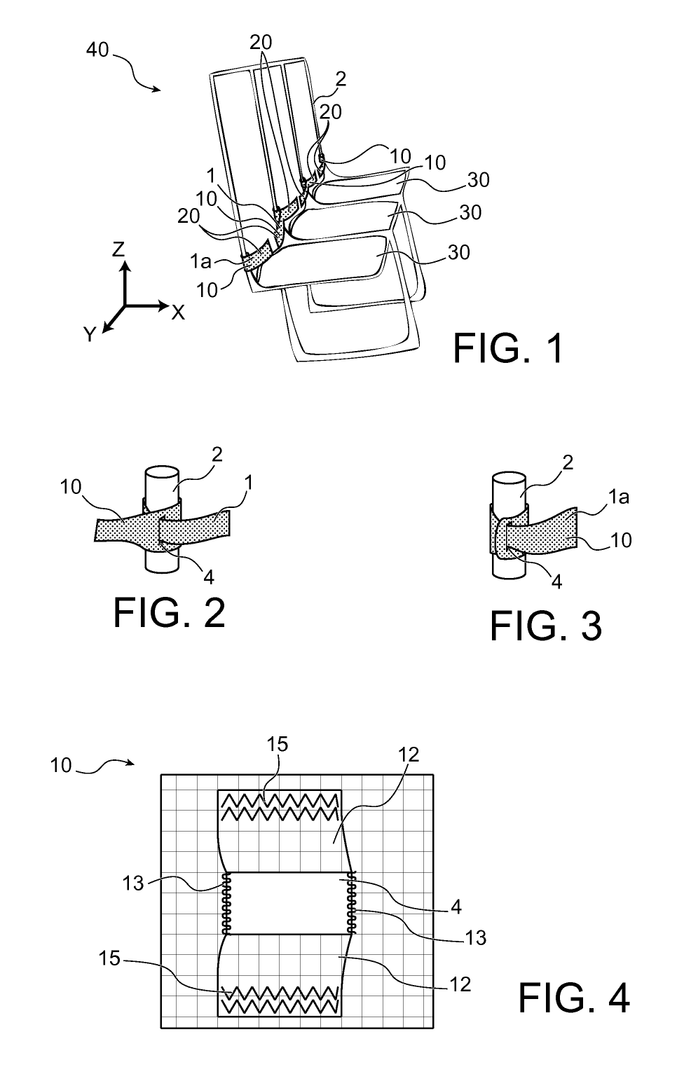

In reference to FIGS. 1 to 10, examples of implementation of the invention shall be described hereinafter.

FIG. 1 shows, in perspective, an example of a set 40 according to the invention comprising three adjacent seats 30 and four textile strips 10 according to the invention.

Each textile strip 10 partially forms a safety belt 20 of a seat 30. In particular, each textile strip 10 located at one end of the set 40 forms half of the safety belt 20 of the corresponding seat 30, and the two central textile strips 10 each forming one half of a first seat belt 20 and one half of a second safety belt 20.

Each textile strip 10 is attached to a fixed structure 2 of a seat 30 according to a method of fastening in accordance with the invention.

The function of the system or principle of fastening the safety belt is to transfer the forces sustained by the passenger in the case of an impact to the structure. The safety belt is as such attached during the travel, surrounding the passenger. During an impact, the passenger is projected forwards (axis X of FIG. 1), and is retained by the safety belt. The belt then exerts a force mainly according to the X axis, possibly according to the Y axis in case of lateral impact, and more rarely according to the axis Z is case of rolling over or free fall. As the speed of the passenger in relation to the ground is according to the X axis, most of the impacts take place according to this direction.

For an optimum transfer of the force from the belt to the structure, it is suitable to minimise the number of intermediate parts. Each additional part can indeed be a point of weakness in the chain of transfer, complicating the fastening system, and increases the complexity of the mounting and follow-up for parts.

The system or principle of fastening according to the invention can provide a transmission, without intermediate fastening, of the forces sustained by the safety belt. The safety belt is folded onto itself in order form a buckle, said buckle surrounds a fixed portion of the seat or of the passenger compartment. During an impact, the buckle is thrust against the fixed portion of the structure, and as such transfers the effort. Regardless of the mode of forming of the buckle, it is always more favourable to have a buckle with a width that is wider than the rest of the belt, in order to distribute the force over a large surface area of the fixed structure, and to decrease in proportion the pressure exerted locally on this structure.

In order for the fastening system to operate, the buckle has to be surrounded around the structure, then during the impact, the buckle does not disintegrate. The formation of the buckle can be carried out by gluing (use of a hardening resin around the structure) or insertion (passing one end of the textile strip into a notch).

Each textile strip 10 can as such be carried out in accordance with what has been described previously.

For example, the textile strip can comprise a notch 11 in order to allow for the folding of the textile strip 10 onto itself in such a way as to surround a fixed structure 2 of a seat 30 or of the passenger compartment of a vehicle comprising the seat, by inserting one end 1 or 1a of the textile strip 10 into the notch 11 made in the latter. Such an embodiment is shown in reference to FIGS. 2 to 7.

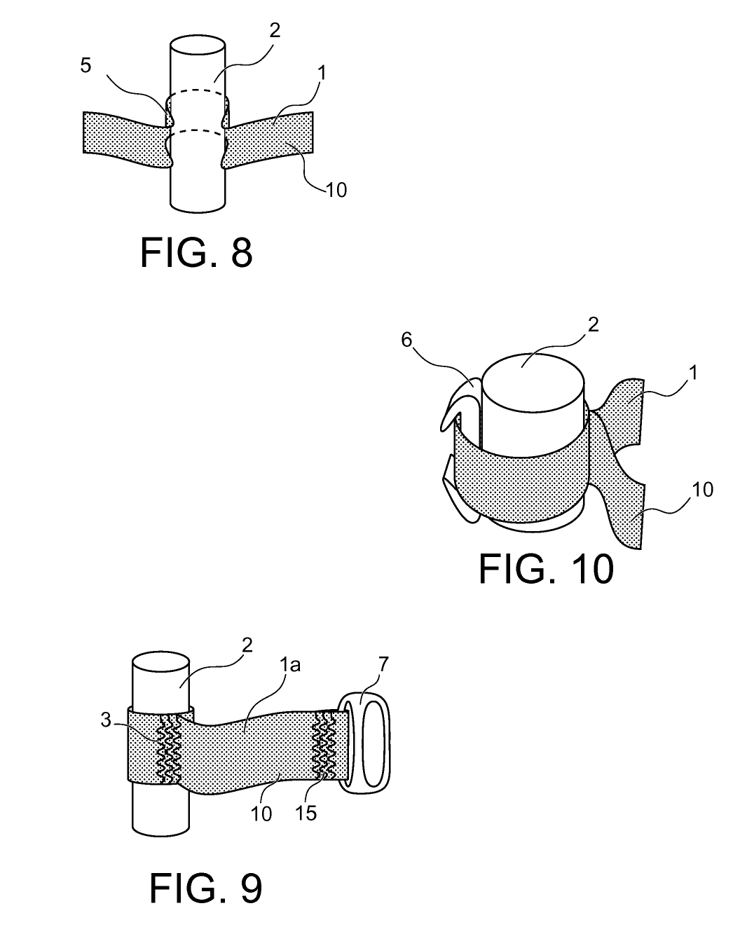

The textile strip 10 can further comprise, over at least one zone 5 of the latter intended to surround the fixed structure 2 of a seat 30 or of the passenger compartment of a vehicle, a thermosetting resin pre-impregnated on the textile strip 10 or a thermoplastic resin. Such an embodiment is shown in reference to FIG. 8.

The FIGS. 2 and 3 show the positioning of the textile strip 10 around a fixed structure 2 of a seat 30 or of a passenger compartment, by inserting an end 1 or 1a of the textile strip 10 through a notch 4 made in the textile strip 10.

More particularly, FIG. 2 shows an example of forming the buckle by insertion, with one of the free ends 1 forming a buckle around the fixed structure 2 before being inserted into the notch 4 present on the textile strip 10, in particular the other free end, in such a way as to form two ends that can be used. FIG. 3 adapts this buckle to the case where only one end 1a of the buckle is free: in this case, the free end 1a is necessarily the one that is inserted into the notch 4, which is formed in the other end.

In the case of a buckle made via insertion or notch, the typological type of the fixed structure 2 is without importance: the buckle can be formed as many times as required by simple passage of one end 1 or 1a of the textile strip 10 in a notch 4 made in the other end of the strip. The notch 4 must be carried out in such a way as to not limit the transfer of the forces in the direction of the textile strip 10, and in such a way as to not weaken the textile passing through the notch 4. In particular, the weft threads must not be cut on the notch 4, and the edges of the notch 4 must be reinforced so as not to fray the textile strip 10 passing through it, or be weakened by the latter.

In terms of resistance to impact, the notch 4 is a potential point of weakness of the fixed structure 2, and must consequently be as small as possible. The transfer of force to the fixed structure 2 is comparable to the case of a sewn buckle. The advantage of the formation by insertion or notch is its flexibility: the buckle can easily be unbuckled and rebuckled, allowing for easy replacement of the safety belt in case of deterioration of the textile strip or of the fastener. An additional system of reversible blocking of the buckle can be arranged in order to protect against the possibility for the passenger to undo the fastening system without a tool. An alternative consists in lot leaving the buckle accessible, with the seat or the seatback able to conceal the system for fastening the belt.

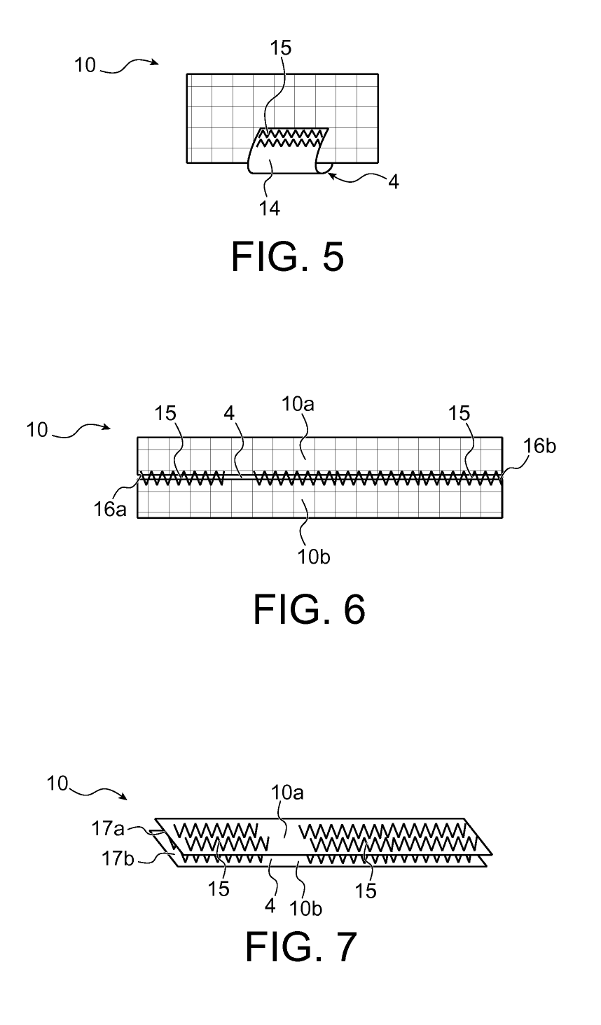

FIGS. 4 and 5 show, diagrammatically and partially, embodiments that allow for a reinforcement of at least one portion of the contour of a notch 4 of a textile strip 10.

In the two cases, the textile strip 10 is cut in order to form the notch 4.

The fabric forming a safety belt 20 is conventionally oriented in two privileged directions, the weft and the warp, with one of the two directions being in the axis of the textile strip 10. More preferably, the notch 4 is cut in the direction of the weft and of the warp.

FIG. 4 shows the possibility to improve the resistance to wear and tear of the notch 4 by folding cut portions 12 of the textile strip 10 onto itself, with these cut portions 12 being sewn with a double thickness on stitches 15 on the textile strip 10. The friction as such takes place on continuous threads, and no longer on the ends of more fragile threads.

Moreover, an extra sewing 13 can also be made on at least one portion of the contour of the notch 4.

FIG. 5 shows the possibility of using a material 14 surrounding at least one portion of the contour of the notch 4, with the material 14 being sewn on the textile strip 10 on stitches 15, on either side of the contour of the notch 4. The friction can as such take place on textile added by the material 14 and not on the threads of the textile strip 10.

Another possibility (not shown), can consist in adding on the border of the notch 4, a metal such as stainless steel, aluminium or titanium, able to pinch the free ends of the threads of the textile strip 10, or a curable material such as a thermosetting resin or a thermoplastic resin, able to agglomerate the free ends of the threads of the textile strip 10. These two possibilities make it possible to prevent fraying.

FIGS. 6 and 7 show two possibilities for carrying out a textile strip 10 according to the invention with notch 4.

According to these two possibilities, the notch 4 is created by sewing two textile sub-strips 10a and 10b over their entire length, except on the notch 4. The sewing 15 can be highly resistant and the contour of the notch 4 can be as such constituted of continuous threads and not cut threads.

The two textile sub-strips 10a and 10b can be sewn according to their edge 16a and 16b longitudinally, as shown in FIG. 6, except on the notch 4.

Alternatively, the two textile sub-strips 10a and 10b can be sewn by their face 17a and 17b, except on the notch 4 intended to be formed.

FIG. 8 shows the possibility of having a textile strip 10 comprising, over at least one zone 5 of the latter, surrounding the fixed structure 2 of a seat 30 or of a passenger compartment, a thermosetting resin, pre-impregnated on the textile strip 10, or a thermoplastic resin.

The use of a glue or resin, in particular a thermosetting resin or a thermoplastic resin, can make it possible to obtain a composite rigid textile buckle, that can be independent of the fixed structure 2.

In such a case of a buckle made by gluing or resin, the typological type of the fixed structure 2 hardly matters: the buckle is formed in situ, by thrusting (or gluing) the textile strip 10 around the fixed structure 2. The material constituting the fixed structure 2 must not be weakened by the rigidification or gluing operation, whether this is by chemical reaction with the glue or resin, or by degradation following a local rise in temperature. The buckle is not necessarily closed in the case of gluing, as a simple arc of circle can be sufficient in mechanical terms, as long as the angle covered is strictly greater than 180 arc degrees (π radians). By precaution, it is suitable to cover at least 240 arc degrees (2π/3 radians). In FIG. 8, the carrying out of the buckle is shown with two free ends 1 of the textile strip 10.

In terms of resistance to impact, the technique of gluing (or resin) makes it possible to carry out a composite material that combines the textile strip and the resin. This material is continuous with the rest of the textile strip, there is no interface problem with the safety belt properly speaking The glue or resin chosen can make it possible to make the buckle particularly solid. If the shape of the buckle hugs that of the structure, the entire surface of the buckle allows for an energy transfer in the case of impact: the force is exerted over a large surface, reducing the pressure exerted on the structure, and limiting the deformation or the explosion of the fixed portion.

In the two cases presented previously (use of a notch or of a resin), the number of parts constituting the system for fastening the safety belt 20 is greatly reduced in relation to a conventional system. This greatly simplifies the assembly, even if the fastening of the belt has to be incorporated during the manufacture of the seat 30, a portion of the fixed structure 2 having to be able to be surrounded by the safety belt 20. This also simplifies the follow-up of the quality of the parts: for safety elements, following-up on parts is an integral portion of the quality initiative. In the case with transportation by aircraft for example, the manufacturer must be able to track all of the operations carried out on a part intended to be brought on board. By minimising the number of parts and operations, this system for fastening facilitates following-up on parts.

In order to limit the constraint that forming the textile buckle during the manufacture of the seat 30 constitutes, it is possible to increase the flexibility of the system for fastening while still reducing the weight in relation to a conventional attaching system.

FIG. 9 shows the possibility of providing the textile strip 10 with a solid support 7 allowing for the attaching of a snap hook. In this case, the free end 1a can be sewn around the support 7, which can then be used to connect the textile strip 10 of the belt 20 to the system for fastening. Conventional belts with snap hooks can be attached on this support 7, and be removed easily.

The example of FIG. 9 shows a buckle formed around the fixed structure 2 by sewing 3, not in accordance with the invention. Of course, the buckle could be formed using a notch 4 or by using a resin, in accordance with the invention, and the presence of the solid support 7 can be provided for these two embodiments.

Such a system is less economical in terms of weight than a continuous textile system for the fastening of the safety belt, with the intermediate solid support and the snap hook having to be added, but it is much more flexible. It combines the flexibility of the conventional fastening system and the textile fastening on the structure, which slightly decreases the overall weight in relation to a conventional unit.

The system for fastening can fulfil another function in addition to the consisting in transferring the forces from the belt 20 to a fixed structure 2: it can absorb the impact in order to transfer the forces more gently, and prevent the deformation or the explosion of the fixed structure 2. The conventional strategy is based on the elasticity of the textile strip 10 of the safety belt 2: by elastically stretching during the impact, the belt 20 stretches the time of the energy transfer, and as such decreases the intensity of the force exerted on the fixed structure 2. But this strategy is limited by the frontal impact of the passenger: if the belt 20 stretches too much, the passenger risks becoming crushed in front of the seat 30 or in front of another fixed structure of the passenger compartment.

FIG. 10 shows the possibility of improving the fastening system with an absorber 6, for example of the gel or foam type, as such decreasing the pressure exerted on the fixed structure 2. The absorber 6 acts in two ways: on the one hand, it can be deformed, by stretching over time the energy transfer, and as such decreasing the force exerted on all of the fixed structure 2; on the other hand, it can distribute this force over a greater surface area, as such reducing the pressure exerted locally on the fixed structure 2.

The elastic deformation of the gel or of the foam is similar to the elasticity of the safety belt 20, except that the deformation entails the thickness of the absorber 6, not the length of the belt 20: with the same clearance, it is possible to slow down the impact more effectively. The spatial distribution can be carried out thanks to the textile buckle: during the impact, the absorber 6 placed between the buckle and the fixed structure 2 is thrust against the fixed structure 2. If the shape of the absorber 6 hugs that of the fixed structure 2, the contact surface is no longer that of the buckle, but that of the absorber 6, potentially much greater. The difficulty consists in that the absorber 6, which by definition is deformable, remains in position between the installation of the buckle and the occurrence of the impact. In FIG. 10, the absorber 6 is inserted into the textile buckle, thrust against the fixed structure 2: its shape, concave on the side of buckle, allows it to remain in place, and the surface in contact with the fixed structure 2 is more substantial than the surface that the textile buckle would have had.

Moreover, as can be seen in FIG. 1, a possibility of the principle of fastening of the invention consists in coupling two adjacent belts 20. Currently, two adjacent belts each have their point of attaching to the fixed structure and their textile strip. By forming a textile buckle, it is possible to use one or two of the ends of the buckle for safety belts 20. FIG. 1 shows the case of a bench with three seats, where only four textile strips 10 (two doubles 1 and two singles 1a) are required to carry out the three safety belt 20, instead of six currently.

For buckles that have two free ends 1, care must be taken that the two safety belts 20 are independent: it is entirely possible that during the impact, one of the two belts is not used. The buckle must therefore be able to operate with one or two passengers, without interaction between the two passengers if they are present simultaneously during the impact. In practice, only the glued structure guarantees rigorous independence between the two belts. In the case of a sewn or inserted buckle, the latter can slightly turn rotate around the axis of the fixed structure 2 according to the order of the impacts. A first impact on the right will tend to displace the junction point of the two free ends towards the right, before a second on the left again pulls on the junction point.

This slight coupling between the two ends is not necessarily a disturbance, as the displacement of the junction point is an additional absorber of the impact, although a weak one. It is however important to dimension the resistance of the junction point to these two successive lateral forces, and to design the absorber in such a way that it can be effective for the two impacts, including after rotation of the textile buckle.

The materials chosen to form the textile buckle or textile strip 10 must comply with the same standards in effect according to the mode of transport in question, in particular in terms of toxicity, flammability or transmission of heat.

The mechanical resistance of the textile strip 10 has to be sufficient in order to retain a passenger during an impact. Polyamide (for example nylon) or aramid (for example Kevlar® or Twaron®) fibres are particularly suited to its manufacture.

The textile buckle transfers the impact sustained by the passenger to the fixed structure 2 of the seat or of the passenger compartment. So that the impact can be transmitted in fine to the passenger compartment, it is suitable to have a cylindrical topology structure on the fastening point of the belt that is sufficiently resistant. This requires that thought be given at the design stage of the seat 30 to the fastening of the belt: the latter cannot be adapted to all types of seat by simple screwing.

In order to optimise the energy transfer during the impact, and in particular in order to distribute it over a surface that is as large as possible, it is suitable to enlarge the textile strip 10 on the buckle. As the transfer is made by the portion of the textile buckle in contact with the structure 2, the wider the buckle is, the larger the contact surface will be, and the less the pressure exerted on the material will be.

In several of the embodiments presented here, the textile buckle is formed during the manufacture of the belt. It must therefore in certain cases be inserted around the structure 2 of the seat 30 or of the passenger compartment during the carrying out of the latter, and not on a finished structure. The formation of the buckle via insertion is here the most flexible.

The cylindrical topology makes it possible to prevent sharp edges that can progressively fray the textile strip 10 before a possible impact, via simple friction. It also facilitates the rotation of the textile buckle around the axis of the structure 2, which allows the passenger to adjust the angle between the end of the belt and the seatback of the seat 30, so as to provide for minimum comfort.

In order to form the textile buckle via insertion (or notch), one of the two free ends 1 or the portion opposite the free end 1a must be notched. The notch 4 must be wide enough so that the unnotched end can pass through to the inside.

The notch 4 is subject to several precautions. The first relates to its manufacture: it is suitable as much as possible to not simply cut a textile strip, but to weave the textile strip by leaving a free space. In practice, this means that the weft of the textile of the belt must be open on the notch 4, and that the warp is interrupted on the notch 4. The continuity of the weft, in the direction of the textile strip 10, allows for a continuous transfer of the force in case of impact, without thread being stopped on the notch 4. This prevents a pure and simple tearing of the notch 4.

The second precaution relates to the edges of the belt 20 and of the notch 4. In order to prevent the friction between these two portions from fraying the textile strip 10, it is suitable to extra stitch the edges of the notch 4 and the portion of the textile strip 10 that is inserted therein, over a length of about a centimetre n order to take the clearance linked to the use of the safety belt 20 into account.

Finally, in order to prevent the buckle from being too loose, the portion of the textile strip 10 that is inserted into the notch 4 can be slightly wider than at the exit of the notch 4. During the insertion into the notch 4, the free end can be folded in the direction perpendicular to that of the textile strip 10, then unfolded after insertion. This makes it possible to pass a textile strip 10 that is wider than the size of the notch 4, and then prevents the notch 4 from excessively navigating along the textile strip.

In order to form the textile buckle by thrusting or gluing (using a resin), two strategies are possible as indicated previously. A first possibility is to use a textile strip 10 pre-impregnated with a resin on the portion 5 intended to form the buckle. The matrix can for example be an epoxy resin. The pre-impregnated portion 5 is then thrust using a mould against the structure 2 and an increase in temperature allows for the polymerisation of the resin. It is then sufficient to remove the mould, and the buckle is formed. The temperature to apply depends on the type of resin: with phenolic resins requiring between 120 and 150° C., epoxy resins between 50 and 160° C. according to the precise type of polymer and the fabric chosen.

A second possibility, consists in coating the textile strip 10 with resin after having positioned it against the structure 2. The resin can be sprayed with a gun, or spread using a brush or a syringe. The resin/hardener mixture is already carried out, and the resin polymerises directly on the fabric. This strategy can be used if the rise in temperature is not compatible with the stability of the structure 2 (the case for example with a thermoplastic structure): it is sufficient to send slightly hot air for several hours so that the resin/hardener mixture polymerises. The high temperatures linked to the use of a pre-impregnated textile are as such avoided.

Concerning the fastening of an intermediate support 7 for the attaching by snap hook of the textile strip 10 of the safety belt, the easiest and incidentally the lightest consists in sewing the end of the textile strip 10 exiting the fastening buckle around the support 7. FIG. 9 shows such a sewing 15. Again, the sewing 15 has to occur over a distance of about a centimetre, with a thread at least as resistant as the textile strip 10, and with a solid stitch, of the zig-zag type.

The solid support 7 can be a simple torus or a surface of typological type 2 (case shown in FIG. 9). The torus is probably the lightest, but the risk is that the snap hook little by little drays the sewing by friction: the typological type 2 makes it possible to separate the snap hook and the sewing. The support 7 can be constituted of metal, for example of steel or of aluminium formed in a foundry, or of composite material in order to lighten its weight, for example of Kevlar® formed using an epoxy matrix.

In the case of the use of an intermediate support 7, the same support can make it possible to fasten two adjacent belts.

The insertion of an absorber 6, whether it be a gel or foam absorber, must be carried out at the time the buckle is formed. The shape of the absorber 6 must allow it to remain in the buckle during the life of the belt. In particular, vibrations or frequent rotations of the buckle must not bring the absorber 6 towards the front of the buckle. A concave shape, wherein the textile strip 10 can be inserted in the concavity by being initially folded, guarantees that the absorber 6 will not exit the buckle. A slight fastening to the textile strip 10, such as glue or a self-gripping strip, can assist in maintaining the absorber 6 in place.

The gel absorber can be carried out by imprisoning a silicone in an airtight bag that has the desired shape. The thickness is then a few millimetres. In the case of a foam absorber, the silicone is replaced with a foam, for example expanded polystyrene. A bag can either be filled using fragments of expanded polystyrene, or sculpt a block of foam in order to give it the desired shape.

In the case of formation via insertion, it is sufficient to place the absorber 6 at the centre of the textile buckle. In the case of forming the buckle via thrusting (or gluing), the absorber 6 has to be present during the thrusting (or gluing), with the textile strip 10 being thrust against the absorber 6 where the latter is present, and against the structure 2 on the remainder of the buckle.

Of course, the invention is not limited to the example embodiments that have just been described. Various modifications can be made to it by those skilled in the art.

1. Textile strip forming at least partially a safety belt intended to be fastened to a fixed structure of a seat or of a passenger compartment, wherein a notch is formed on the textile strip in order to allow for the folding of the textile strip onto itself in such a way as to surround the fixed structure of the seat or of the passenger compartment via insertion of an end of the textile strip into the notch made in the textile strip.

2. Textile strip according to claim 1, wherein the notch is carried out by cutting the textile strip in the direction of the weft and of the warp.

3. Textile strip according to claim 1, wherein at least one portion of the contour of the notch is reinforced by a folding of a cut portion of the textile strip on the textile strip and sewing of the cut portion on the textile strip.

4. Textile strip according to claim 1, wherein at least one portion of the contour of the notch is reinforced by extra sewing.

5. Textile strip according to claim 1, wherein at least one portion of the contour of the notch is reinforced by the adding of a material surrounding said at least one portion of the contour of the notch, with this material being sewn on the textile strip on either side of said at least one portion of the contour of the notch.

6. Textile strip claim 1, wherein at least one portion of the contour of the notch is reinforced by the adding of a curable material on said at least one portion of the contour of the notch.

7. Textile strip according to claim 1, wherein at least one portion of the contour of the notch is reinforced by the adding of a metal on said at least one portion of the contour of the notch.

8. Textile strip according to claim 1, wherein it comprises two textile sub-strips sewn together longitudinally edge to edge, partially in such a way as to form the notch between the unsewn edges of the two sub-strips.

9. Textile strip according to claim 1, wherein it comprises two textile sub-strips sewn together longitudinally face to face, partially in such a way as to form the notch between the unsewn faces of the two sub-strips.

10. (canceled)

11. Textile strip according to claim 1, wherein a solid support, allowing for the fastening of a snap hook, is fixed to one end of the textile strip.

12-13. (canceled)

14. Textile strip according to claim 1, wherein each end of the textile strip is provided with an attaching support of a safety belt.

15. Seat having a textile strip forming at least partially a safety belt fastened to the seat and a notch formed on the textile strip that allows for the folding of the textile strip onto itself as to surround the fixed structure of the seat via insertion of an end of the textile strip into the notch.

16. (canceled)

17. Seat according to claim 15, wherein an absorber is inserted between the textile strip and the fixed structure.

18. Seat according to claim 17, wherein the absorber is constituted of a gel, dissipating an impact by deformation and by heating.

19. Seat according to claim 17, wherein the absorber is constituted of a foam delaying an impact by deformation, possibly elastic.

20. Seat according to claim 15, wherein the textile strip surrounds the fixed structure without intermediate fastening.

21. Set of at least two adjacent seats comprising first and second adjacent seats, wherein at least one of the first and second seats is a seat having a textile strip forming at least partially a safety belt fastened to the seat and a notch formed on the textile strip that allows for the folding of the textile strip onto itself as to surround the fixed structure of the seat via insertion of an end of the textile strip into the notch, and in that the textile strip forms at least partially the safety belt of the first seat and the safety belt of the second seat.

22-25. (canceled)

26. Method of fastening a safety belt to a fixed structure of a seat or of a passenger compartment, comprising the following steps:
folding a textile strip on itself in order to form a textile strip buckle surrounding the fixed structure of the seat or of the passenger compartment by inserting one end of the textile strip into the notch made in the textile strip.

27-37. (canceled)
